(19) United States
(12) Patent Application Publication
(10) Pub. No.: US 2007/0034525 A1
(43) Pub. Date: Feb. 15, 2007

(54) Electrolytic processing method

(76) Inventors: Masayuki Kumekawa, Tokyo (JP); Norio Kimura, Tokyo (JP); Yukio Fukunaga, Tokyo (JP); Katsuyuki Musaka, Tarrytown, NY (US); Hariklia Deligianni, Tenafly, NJ (US); Emanuel Israel Cooper, Scarsdale, NY (US); Philippe Mark Vereecken, Vlaams-Brabant (BE)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/203,545

(22) Filed: Aug. 12, 2005

(51) Int. Cl. B23H 9/00

(52) U.S. Cl. 205/640

(57) ABSTRACT

An electrolytic processing method is used to remove a metal film formed on a surface of a substrate. The electrolytic processing method includes providing a feeding electrode 31 and a processing electrode 32 on a table 12, providing an insulating member 36 between the feeding electrode and the processing electrode, holding the substrate W by a substrate carrier 11, bringing the substrate into contact with the insulating member, supplying first and second electrolytic processing liquids to gaps between the feeding electrode and the substrate and between the processing electrode and the substrate, respectively, while the first and second electrolytic processing liquids are electrically isolated, applying voltage between the feeding electrode and the processing electrode, and making a relative movement between the substrate carrier and the table to electrically process the metal film.

### BACKGROUND OF THE INVENTION

1. Field of the Invention

The present invention relates to an electrolytic processing method, and more particularly to an electrolytic processing method for removing a metal film formed on a surface of a substrate such as a semiconductor wafer to a flat finish.

2. Description of the Related Art

In recent years, there has been an eminent movement towards using copper (Cu), which has a low electric resistivity and high electromigration endurance, as a material for forming circuits on a substrate such as a semiconductor wafer, instead of using aluminum or aluminum alloys. Copper interconnections are generally formed by filling copper into fine recesses formed in a surface of a substrate. There are known various techniques for forming such copper interconnections, including chemical vapor deposition, sputtering, and plating. In any such technique, a copper film is formed on a substantially entire surface of a substrate, and then unnecessary copper is removed by chemical mechanical polishing (CMP).

FIGS. 1A through 1C illustrate an example of process of forming such a substrate W having copper interconnections. As shown in FIG. 1A, an insulating film (interlayer dielectric) 2, such as an oxide film of SiO₂ or a film of low-k material, is deposited on a conductive layer 1a on a semiconductor base 1 on which semiconductor devices have been formed. Contact holes 3 and trenches 4 for interconnections are formed in the insulating film 2 by the lithography/etching technique. Thereafter, a barrier layer 5 of TaN or the like is formed on the surface, and a seed layer 7 as an electric supply layer for electroplating is formed on the barrier layer 5 by sputtering, CVD, or the like.

Then, as shown in FIG 1B, copper plating is performed onto the surface of the substrate W to fill the contact holes 3 and the trenches 4 with copper and, at the same time, deposit a copper film 6 on the insulating film 2. Thereafter, the redundant copper film 6 and the barrier layer 5 on the insulating film 2 are removed by chemical mechanical polishing (CMP) so as to make the surface of the copper film 6 filled in the contact holes 3 and the trenches 4 and the surface of the insulating film 2 lie substantially in the same plane. Interconnections composed of the copper film 6 are thus formed as shown in FIG 1C.

Components in various kinds of equipments have recently become finer and have required higher accuracy. As submicron manufacturing technology has commonly been used, the properties of materials are greatly influenced by the processing method itself Under these circumstances, in a conventional machining method in which a desired portion in a workpiece is physically destroyed and removed from the surface thereof by a tool, a large number of defects may be produced by the processing, thus deteriorating the properties of the workpiece. Therefore, it becomes important to perform processing without deteriorating the properties of the materials.

Some processing methods, such as chemical polishing, electrolytic processing, and electrolytic polishing, have been developed in order to solve this problem. In contrast to the conventional physical processing, these methods perform removal processing or the like through chemical dissolution reaction. Therefore, these methods do not produce defects, such as formation of an altered layer and dislocation, due to plastic deformation, and hence processing can be performed without deteriorating the properties of the materials.

Chemical mechanical polishing (CMP), for example, generally requires a complicated operation and control, and needs a considerably long processing time. In addition, a sufficient cleaning of a substrate must be conducted after the polishing because a slurry (a polishing liquid) is used in the CMP process. This process also imposes a considerable load on the waste disposal of the slurry and the cleaning liquid. Accordingly, there is a strong demand for omitting CMP or reducing a load upon the CMP process. Further, a low-k material, which has a low dielectric constant, is expected to be used as interlayer dielectric in the future. However, the low-k material has a low mechanical strength and therefore is hard to endure the stress applied during the CMP process. Thus, also from this standpoint, there is a demand for a process that enables the flattering of a substrate without imposing any stress on the substrate.

In the conventional CMP process, a certain polishing rate (e.g. 500 nm/min) is required in practical use. Accordingly, a polishing pressure should be increased, for example, to about 350 kPa to increase a polishing rate. The polishing rate in the CUT process is determined by the following Preston equation.
RR=kPV
In the above equation, RR represents a polishing rate (m/s), k constant (Pa⁻¹), P a polishing pressure (Pa), and V a relative speed between a substrate and a polishing surface (m/s).

It can be seen from the Preston equation that a polishing pressure P or a relative speed V should be increased during polishing to maintain a certain polishing rate. In such a case, a surface of a substrate becomes likely to be scratched or chemically damaged. Further, dishing or recesses are likely to be produced to cause lean interconnections. Accordingly, the resistance of interconnections is problematically increased, and the reliability of interconnections is lowered by defects of the interconnections.

### SUMMARY OF THE INVENTION

The present invention has been made in view of the above drawbacks. It is therefore an object of the present invention to provide an electrolytic processing method which can flatten a surface of a metal film having fine irregularities on a substrate with a low processing pressure upon formation of interconnections using damascene process, and can process the metal film with a uniform processing rate over an entire surface of the metal film.

In order to solve the above drawbacks, according to one aspect of the present invention, there is provided an electrolytic processing method for processing a substrate having a metal film formed on a surface thereof, the method comprising: providing at least one feeding electrode and at least one processing electrode on a table; providing an insulating member between the feeding electrode and the processing electrode; holding the substrate by a substrate carrier in such a state that the metal film faces the feeding electrode and the processing electrode; bringing the substrate into contact with the insulating member; supplying a first electrolytic processing liquid and a second electrolytic processing liquid to gaps between the feeding electrode and the substrate and between the processing electrode and the substrate, respectively, while the first electrolytic processing liquid and the second electrolytic processing liquid are electrically isolated; applying voltage between the feeding electrode and the processing electrode; and making a relative movement between the substrate carrier and the table to electrically process the metal film.

According to the present invention, an electrolytic processing is performed as follows: Since the first electrolytic processing liquid at the feeding electrode side and the second electrolytic processing liquid at the processing electrode side are electrically isolated by the insulating member, electric current flows from the feeding electrode to the processing electrode through the metal film on the substrate. At this time, electric potential of the metal film on the substrate is substantially equal to that of the feeding electrode due to the first electrolytic processing liquid. On the other hand, electrons are supplied to the metal film through the second electrolytic processing liquid. As a result, at the processing electrode side, the metal film is ionized to elute by the electrons supplied, and complex is formed in the surface of the metal film in the second electrolytic processing liquid. In this state, when making a relative movement between the insulating member and the substrate, the complex in the convex portions of the metal film is selectively removed by the insulating member, and hence the surface of the metal film is flattened.

In this manner, according to the present invention, because the first electrolytic processing liquid and the second electrolytic processing liquid are electrically isolated by the insulating member, feeding of electricity to the metal film, to be processed, on the substrate can be securely performed, and electrolytic processing on a portion of the metal film facing the processing electrode can also be securely performed. As a result, a processing pressure can be lowered, and a desired processing rate can be ensured while suppressing damage to the substrate, resulting in an increased throughput.

Here, processing steps for a substrate using the present invention will be described with reference to FIGS. 2A through 2D. As shown in FIG. 2A, an insulating film 2 is deposited on a conductive layer 1 a which is formed on a semiconductor base 1. Contact holes 3 and trenches 4 are formed in the insulating film 2, a barrier layer 5 is formed on the surface of the insulating film 2, and a seed layer 7 is formed on the barrier layer 5. Then, as shown in FIG. 2B, copper plating is performed onto the surface of the substrate W to fill the contact holes 3 and the trenches 4 with copper and, at the same time, deposit a copper film 6 on the insulating film 2. Thereafter, as shown in FIG. 2C, the copper film 6 is removed to a level near the barrier layer 5 with a low processing pressure (e.g., 70 kPa) by the electrolytic processing method of the present invention, so that the irregularities on the copper film 6 are removed. After the electrolytic processing, the remaining copper film 6, the barrier layer 5, and the seed layer 7 are removed by a CMP apparatus with a low pressure and a low processing rate, as shown in FIG. 2D. According to the present invention, processing time of the CMP apparatus can be shortened, and hence load on the substrate can be reduced.

In a preferred aspect of the present invention, the relative movement between the substrate carrier and the table is performed in such a manner that a predetermined processing point of the metal film passes over the processing electrode and the insulating member alternatively.

According to the present invention, the complex formed in the surface of the metal film is securely removed by the insulating members.

In a preferred aspect of the present invention, the first electrolytic processing liquid is supplied through a plurality of openings formed on an upper surface of the feeding electrode, and the second electrolytic processing liquid is supplied through a plurality of openings formed on an upper surface of the processing electrode.

According to the present invention, the first and second electrolytic processing liquids can be supplied evenly over the metal film on the substrate.

In a preferred aspect of the present invention, a plurality of weirs are provided so as to surround the plurality of openings so that the first electrolytic processing liquid is retained on the upper surface of the feeding electrode and the second electrolytic processing liquid is retained on the upper surface of the processing electrode.

According to the present invention, because the first electrolytic processing liquid and the second electrolytic processing liquid are retained respectively on the upper surfaces of the feeding electrode and the processing electrode, the metal film can be securely energized through the first electrolytic processing liquid and the second electrolytic processing liquid.

In a preferred aspect of the present invention, the insulating member is a single piece disposed so as to cover the feeding electrode and the processing electrode, and the first and second electrolytic processing liquids are supplied to the metal film through through-holes formed in the insulating member.

According to the present invention, a smooth contact surface having no gap is provided on the upper surface of the insulating member. Therefore, it is possible to prevent the metal film of the substrate from being damaged and to facilitate attachment of the insulating member.

In a preferred aspect of the present invention, the electrolytic processing is performed while the substrate is in sliding contact with the insulating member comprising an elastic pad.

According to the present invention, close contact between the substrate and the insulating member (elastic pad) can be improved, and hence the electrical isolation between the first electrolytic processing liquid and the second electrolytic processing liquid can be ensured. Further, scratches can be prevented from being produced on the surface of the substrate when the substrate is brought into contact with the elastic pad.

In a preferred aspect of the present invention, the electrolytic processing is performed while the substrate is in sliding contact with the insulating member comprising a fixed abrasive pad.

According to the present invention, flatness of the metal film can be improved.

In a preferred aspect of the present invention, the elastic pad is a resin pad having a sawtooth cross section.

According to the present invention, passive film such as complex formed in the convex portions of the surface of the metal film can be effectively removed by convex portions of the pad, and the removed passive film can be discharged through concave portions of the pad.

In a preferred aspect of the present invention, an elastic member is disposed between the table and the insulating member.

According to the present invention, a pressure exerted from the insulating member to the substrate can be evened over the entire surface of the insulating member.

In a preferred aspect of the present invention, the electrolytic processing method further comprises circulating the first electrolytic processing liquid and the second electrolytic processing liquid independently while keeping electrical insulation.

According to the present invention, since the first electrolytic processing liquid and the second electrolytic processing liquid can be recovered and reused, cost required for the first electrolytic processing liquid and the second electrolytic processing liquid can be reduced.

In a preferred aspect of the present invention, main components contained respectively in the first electrolytic processing liquid and the second electrolytic processing liquid are the same as each other.

In a preferred aspect of the present invention, concentrations of the main components contained respectively in the first electrolytic processing liquid and the second electrolytic processing liquid are the same as each other at a time of starting the electrolytic processing.

In a preferred aspect of the present invention, the relative movement between the substrate carrier and the table comprises at least one of rotating motion of the substrate carrier, swinging motion of the substrate carrier, and translating motion of the substrate carrier.

In a preferred aspect of the present invention, the relative movement between the substrate carrier and the table comprises scrolling motion of the table.

According to the present invention, the insulating member can be brought into contact with the entire surface of the substrate, and hence uniform processing can be further improved over the surface of the substrate.

In a preferred aspect of the present invention, a plurality of the feeding electrodes and a plurality of the processing electrodes are arranged alternately.

According to the present invention, electricity can be fed to a large area of the metal film by the plurality of the feeding electrodes through the first electrolytic processing liquid. Further, the entire surface of the metal film on the substrate can be securely processed by the plurality of the processing electrodes.

In a preferred aspect of the present invention, a stroke of the relative movement between the substrate carrier and the table is equal to or larger than an interval of the plurality of the processing electrodes.

According to the present invention, it is possible to prevent partially unprocessed portion from remaining in the metal film on the substrate and to further ensure the processing of the entire surface of the metal film.

In a preferred aspect of the present invention, a thickness distribution of the metal film is adjusted by changing a distance between each of the plurality of the processing electrodes and the substrate.

In a preferred aspect of the present invention, the processing electrode is divided into a plurality of electrode parts aligned in a longitudinal direction of the processing electrode.

In a preferred aspect of the present invention, a thickness distribution of the metal film on the substrate is adjusted by controlling a distribution of currents to be supplied to the plurality of the processing electrodes.

According to the present invention, it is possible to solve non-uniform processing rate which would be caused by non-uniform supply of the electrolytic processing liquid or non-uniform relative speed between the substrate and the table over the substrate.

According to another aspect of the present invention, there is provided a substrate processing method comprising: removing a substrate from a load and unload unit; electrically processing a metal film formed on the substrate; after the electrical processing, cleaning and drying the substrate; and returning the substrate to the load and unload unit; wherein the electrical processing comprises: bringing the substrate into contact with an insulating member disposed between at least one feeding electrode and at least one processing electrode; supplying a first electrolytic processing liquid and a second electrolytic processing liquid to gaps between the feeding electrode and the substrate and between the processing electrode and the substrate, respectively, while the first electrolytic processing liquid and the second electrolytic processing liquid are electrically isolated; applying voltage between the feeding electrode and the processing electrode; and making a relative movement between the insulating member and the substrate.

In a preferred aspect of the present invention, the substrate processing method further comprises after the electrical processing, polishing the metal film remaining on the substrate.

In a preferred aspect of the present invention, the substrate processing method further comprises before the electrical processing, measuring a thickness of the metal film on the substrate.

### BRIEF DESCRIPTION OF THE DRAWINGS

FIGS. 1A through 1C are diagrams illustrating an example of production of a substrate with copper interconnections;

FIGS. 2A through 2D are diagrams illustrating an example of production of a substrate with copper interconnections using the present invention;

FIG. 3A is a cross-sectional view showing an electrolytic processing apparatus configured to perform an electrolytic processing method according to a first embodiment of the present invention;

FIG. 3B is a cross-sectional view taken along a line III-III shown in FIG. 3A;

FIG. 4 is a perspective view showing an example of an insulating member used in the electrolytic processing apparatus shown in FIGS. 3A and 3B;

FIG. 5A is a cross-sectional view showing another structure of the electrolytic processing apparatus;

FIG. 5B is a cross-sectional view taken along a line V-V shown in FIG. 5A;

FIG. 6 is a cross-sectional view showing an electrolytic processing apparatus configured to perform an electrolytic processing method according to a second embodiment of the present invention;

FIG. 7 is a cross-sectional view showing an electrolytic processing apparatus configured to perform an electrolytic processing method according to a third embodiment of the present invention;

FIG. 8 is a cross-sectional view showing an electrolytic processing apparatus configured to perform an electrolytic processing method according to a fourth embodiment of the present invention;

FIG. 9 is a plan view showing an electrolytic processing apparatus configured to perform an electrolytic processing method according to a fifth embodiment of the present invention;

FIG. 10 is a cross-sectional view showing an electrolytic processing apparatus configured to perform an electrolytic processing method according to a sixth embodiment of the present invention;

FIG 11A is a cross-sectional view showing an electrolytic processing apparatus configured to perform an electrolytic processing method according to a seventh embodiment of the present invention;

FIG. 11B is a plan view of anode electrodes and cathode electrodes when viewed from above;

FIG. 12 is a plan view showing a substrate processing system incorporating the electrolytic processing apparatus;

FIG. 13 is a flow chart showing an operation of the substrate processing system shown in FIG. 12;

FIG. 14 is a flow chart showing an operation of the electrolytic processing unit shown in FIG. 12; and

FIG. 15 is a graph illustrating a relationship between current density of the cathode electrode and processing rate (removal rate).

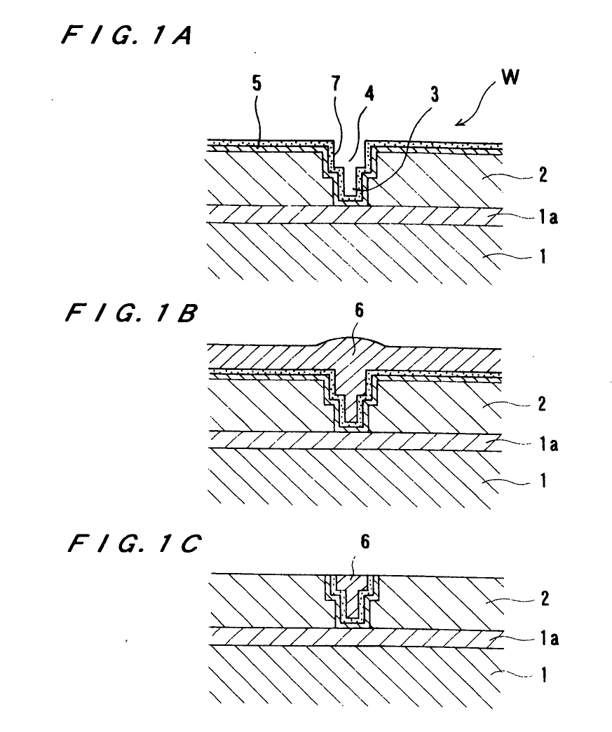

### DETAILED DESCRIPTION OF THE PREFERRED EMBODIMENTS

Embodiments of the present invention will be described below with reference to the drawings. The below-described embodiments refer to electrolytic processing methods for processing a copper film as a metal film formed on a surface of a substrate.

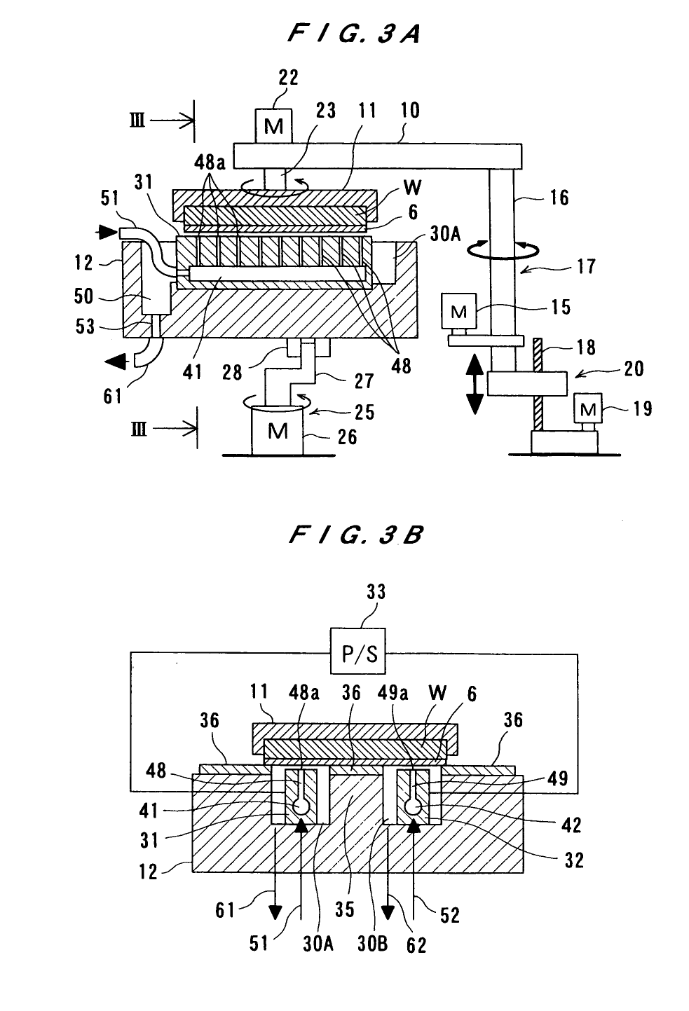

FIG. 3A is a cross-sectional view showing an electrolytic processing apparatus configured to perform an electrolytic processing method according to a first embodiment of the present invention, and FIG. 3B is a cross-sectional view taken along a line III-III shown in FIG. 3A. As shown in FIGS. 3A and 3B, the electrolytic processing apparatus (electrolytic polishing apparatus) comprises an arm 10 which is movable vertically and pivotable horizontally, a disk-like substrate carrier 11, which is connected to a free end of the arm 10, for attracting and holding a substrate W in such a state that a surface on which a copper film 6 is formed faces downward (face down), and a processing table 12 disposed below the substrate carrier 11.

The arm 10 is connected to an upper end of a pivot shaft 16 coupled to a swing motor 15, so that the arm 10 is swung horizontally by the actuation of the swing motor 15. The swing motor 15, the arm 10, and the pivot shaft 16 serve as a swinging mechanism 17, (i.e., a relative movement mechanism) for swinging the substrate carrier 11 in a horizontal plane. The pivot shaft 16 is engaged with a ball screw 18 extending vertically, and is moved up and down together with the arm 10 by the actuation of a vertical-movement motor 19 coupled to the ball screw 18. In this embodiment, the ball screw 18 and the vertical-movement motor 19 serve as a vertical-movement mechanism 20 for moving the substrate carrier 11 vertically. The pivot shaft 16 may be connected to an air cylinder so that the pivot shaft 16 is moved up and down by the actuation of the air cylinder.

The substrate carrier 11 is coupled to a substrate-rotating motor (a rotating mechanism) 22 through a shaft 23, and is rotated about its center by the actuation of the substrate-rotating motor 22 to move the substrate W relatively to the processing table 12. Since the arm 10 can move vertically and pivot horizontally, as described above, the substrate carrier 11 can move vertically and pivot horizontally integrally with the arm 10.

A scrolling mechanism 25 for making a relative movement between the substrate carrier 11 and the processing table 12 is provided below the processing table 12. This scrolling mechanism 25 comprises a scroll motor 26, and a crankshaft 27 coupled to the scroll motor 26. The end portion of the crankshaft 27 is positioned eccentrically from the rotational shaft of the scroll motor 26, and is rotatably engaged with a bearing 28 mounted on a lower surface of the processing table 12. Three or more rotation-prevention mechanisms (not shown) are provided on the lower surface of the processing table 12 for preventing the rotation of the processing table 12 about its own axis.

With such a structure, when the scroll motor 26 is driven, the processing table 12 performs a so-called scrolling motion (translational rotation motion) which is a revolutionary motion without rotation about its own axis. In this case, a radius of this revolutionary motion corresponds to a distance between the rotational shaft of the scroll motor 26 and the end portion of the crankshaft 27. Although the processing table 12 performs the scrolling motion in this embodiment, the present invention is not limited to this. The processing table 12 may performs an oscillatory motion or a reciprocating motion, for example. In case of using a plurality of the processing electrodes, it is necessary to ensure a stroke larger than an interval of the processing electrodes.

The substrate carrier 11 and the processing table 12 are made of an insulating material, and are disposed so as to face each other. Groove-shaped reservoirs 30A and 30B extending in parallel with each other are formed in the upper surface of the processing table 12. A feeding electrode 31 for feeding electricity to the copper film 6 and a processing electrode 32 for processing the copper film 6 are disposed in the reservoirs 30A and 30B, respectively. The feeding electrode 31 is connected to an anode of a power supply 33 to serve as an anode electrode, and the processing electrode 32 is connected to a cathode of the power supply 33 to serve as a cathode electrode. Hereinafter, the feeding electrode will be referred to as the anode electrode and the processing electrode will be referred to as the cathode electrode.

Generally, the electrode has a problem of oxidation or elution due to electrolytic reaction. In view of this, as a material for the electrode, it is preferable to use carbon, relatively inactive noble metals, conductive oxides, or conductive ceramics, rather than metals or metal compounds which have been widely used for the electrode. In this embodiment, a noble-metal-based electrode is used as the feeding electrode 31 and the processing electrode 32. This noble-metal-based electrode is produced by plating or coating platinum (Pt) onto a surface of an electrode of titanium (Ti) and then sintering the coated electrode at a high temperature to stabilize and strengthen the electrode. Such a noble metal-based electrode is advantageous in corrosion resistance and conductivity.

As shown in FIG. 3A, a longitudinal length of the anode electrode 31 and the cathode electrode 32 is set to be larger than a radius of the substrate W. The anode electrode 31 and the cathode electrode 32 extend in parallel with each other, and a partition wall 35 is provided between the anode electrode 31 and the cathode electrode 32. This partition wall 35 is formed from a portion of the processing table 12. The partition wall 35, i.e., the processing table 12, is made of a material which does not allow a liquid to permeate into the processing table 12.

As shown in FIG. 3B, a plurality of insulating members 36 are mounted on the upper surface of the processing table 12. One of these insulating members 36 is disposed on the upper surface of the partition wall 35 and positioned between the anode electrode 31 and the cathode electrode 32. The others are disposed outwardly of the anode electrode 31 and the cathode electrode 32. Upper surfaces of the insulating members 36 are positioned in the same plane, and the surfaces of the anode electrode 31 and the cathode electrode 32 are positioned slightly below the upper surfaces of the insulating members 36 by 0.5 mm, for example. Therefore, when the vertical-movement motor 19 is driven to move the substrate carrier 11 downward, the copper film 6 on the substrate W is brought into contact with the insulating members 36, as shown in FIG. 3B, and small gaps are formed between the anode electrode 31 and the copper film 6 and between the cathode electrode 32 and the copper film 6, respectively. In this manner, the upper surfaces of the insulating members 36 serve as contact surfaces with the substrate W, and the anode electrode 31 and the cathode electrode 32 are kept out of contact with the substrate W (i.e., the copper film 6).

A manifold (a first fluid passage) 41 is formed inside the anode electrode 31 so that the anode liquid (i.e., the first electrolytic processing liquid) passes through the manifold 41. The manifold 41 extends in a longitudinal direction of the anode electrode 31. Similarly, a manifold (a second fluid passage) 42 is formed inside the cathode electrode 32 so that the cathode liquid (i.e., the second electrolytic processing liquid) passes through the manifold 42. The manifold 42 extends in a longitudinal direction of the cathode electrode 32. These manifolds 41 and 42 are connected to a first supply passage 51 and a second supply passage 52, respectively, so that the anode liquid and cathode liquid are supplied to the manifolds 41 and 42 through the first supply passage 51 and the second supply passage 52, respectively.

A plurality of liquid holes 48 communicating with the manifold 41 are formed inside the anode electrode 31. These liquid holes 48 extend vertically and their upper ends are positioned at the upper surface of the anode electrode 31 to form openings 48a. As with the anode electrode 31, a plurality of liquid holes 49 communicating with the manifold 42 are formed inside the cathode electrode 32. These liquid holes 49 extend vertically and their upper ends are positioned at the upper surface of the cathode electrode 32 to form openings 49a. With such structures, the anode liquid, which has been supplied to the manifold 41, is supplied to the gap between the substrate W and the anode electrode 31, and the cathode liquid, which has been supplied to the manifold 42, is supplied to the gap between the substrate W and the cathode electrode 32. The anode liquid and the cathode liquid which have been supplied are stored in the reservoirs 30A and 30B, respectively. The liquid holes 48 and 49 may preferably have an aperture of 1 to 1.5 mm, and interval thereof is preferably in the range of 10 to 15 mm.

As shown in FIG. 3A, a recessed portion 50 is formed in the bottom of the reservoir 30A, and a discharge hole 53 is formed so as to extend downwardly from the bottom of the recessed portion 50. The reservoir 30A is connected to a first discharge passage 61 through the discharge hole 53, so that the anode liquid in the reservoir 30A is discharged to the exterior through the first discharge passage 61. Similarly, a recessed portion and a discharge hole (not shown) are formed in the reservoir 30B in which the cathode electrode 32 is disposed. The reservoir 30B is connected to a second discharge passage 62 through the discharge hole, so that the cathode liquid in the reservoir 30B is discharged to the exterior through the second discharge passage 62.

Next, there will be described an example of a manner of removing the copper film (metal film) 6 formed on the surface of the substrate by etching with use of the above-mentioned electrolytic processing apparatus. Firstly, the vertical-movement motor 19 is driven to move the substrate carrier 11 downwardly until the copper film 6 on the substrate W is brought into contact with the upper surfaces of the insulating members 36. While the substrate W is in contact with the insulating members 36 under a low pressure, the anode liquid is supplied to the gap between the anode electrode 31 and the substrate W, and at the same time, the cathode liquid is supplied to the gap between the cathode electrode 32 and the substrate W. Thereafter, at least one of the swinging mechanism 17, the substrate-rotating motor (rotating mechanism) 22, and the scrolling mechanism 25 is driven to make the relative movement between the substrate W and the processing table 12, thus bringing the insulating members 36 into sliding contact with the copper film 6 on the substrate W. Then, voltage is applied between the anode electrode 31 and the cathode electrode 32 by the power supply 33.

Since the anode liquid and the cathode liquid are electrically isolated by the partition wall 35 and the insulating members 36, the electric current flows from the anode electrode 31 to the cathode electrode 32 through the copper film 6 on the substrate W At this time, the electric potential of the copper film 6 is substantially equal to that of the anode electrode 31 due to the anode liquid which is the electrolytic processing liquid. On the other hand, electrons are supplied to the copper film 6 through the cathode liquid which is the electrolytic processing liquid. As a result, at the cathode side, the copper film 6 is ionized to elute by the electrons supplied, and complex is formed in the surface of the copper film 6 in the presence of the cathode liquid (i.e., the electrolytic processing liquid). In this state, by the relative movement between the substrate carrier 11 and the processing table 12, a certain portion of the copper film 6 passes over the cathode electrode 32 and the insulating members 36 alternately. Thus, the complex formed in the convex portions of the copper film 6 is selectively removed by the insulating members 36, and hence the surface of the copper film 6 is flattened.

The anode liquid which has been supplied to the gap between the substrate W and the anode electrode 31 is stored in the reservoir 30A, and in the same manner, the cathode liquid which has been supplied to the gap between the substrate W and the cathode electrode 32 is stored in the reservoir 30B. At this time, since the two reservoirs 30A and 30B are partitioned by the partition wall 35 and the insulating member 36, electrical isolation between the anode liquid in the reservoir 30A and the cathode liquid in the reservoir 30B is maintained.

It is preferable to use elastic pads as the insulating members 36. The use of the elastic pads can improve the close contact between the substrate W and the insulating members (pads) 36, thus preventing mixing of the anode liquid and the cathode liquid to ensure the electrical isolation. Further, the use of the elastic pads can prevent scratches from being produced on the surface of the substrate W when the substrate W is brought into contact with the elastic pads.

Examples of such pad include IC1000 or Politex (which are manufactured by Rodel, Inc) made of polyurethane and generally used in a CMP apparatus. Further, a fixed abrasive pad may be used in order to improve a flatness of the surface of the substrate to be processed. It is not necessary to form all part of the insulating member 36 with the above-mentioned pad. That is, the pad may be used to form at least the contact surface with the substrate.

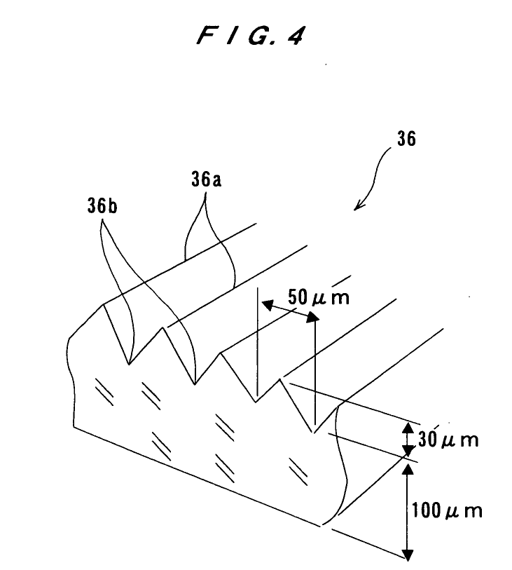

As the above-mentioned pad, a resin pad 36 having a sawtooth cross section may be used, as shown in FIG. 4. In this case, an abrasive free pad is preferably used. The use of such a resin pad can effectively remove passive film such as complex formed in the convex portions of the surface of the copper film 6 by convex portions 36a of the pad 36, and can discharge the removed passive film through concave portions 36b. Further, the abrasive free pad is advantageous in durability compared with the fixed abrasive pad.

Examples of material constituting the resin pad include polyethylene (PE), polypropylene (PP), polytetrafluoroethylene (PTFE), polycarbonate (PC), polyethylene terephthalate (PET), phenol-formaldehyde (PF), and epoxy resin (EP). The material constituting the insulating member 36 should have electrical isolation property itself and should not have open cells, i.e., should not have a liquid permeability. FIG. 4 shows an example in which an interval between the convex portions is 50 μm, a height of the convex portions is 30 μm, and a thickness of the pad is 100 μm. Even in a case where the surface of the pad has fine concave and convex portions, since the pad and the substrate perform relative movement while being in contact with each other, the electrical isolation between the anode liquid and the cathode liquid can be ensured to such a degree that any practical problem does not occur.

Any type of electrolytic processing liquid can be used as the anode liquid to be supplied to the anode electrode 31 inasmuch as electricity can be fed through the anode liquid to the copper film 6 on the substrate W. On the other hand, the cathode liquid to be supplied to the cathode electrode 32 is required to be an electrolytic processing liquid having a property of an etching action itself Therefore, in this embodiment, electrolytic processing liquids which fulfill such requirements are used as the anode liquid and the cathode liquid. In this case, the same kind of electrolytic processing liquid may be used as the anode liquid and the cathode liquid inasmuch as the electrolytic processing liquid fulfills the above-mentioned requirements.

Examples of the anode liquid and the cathode liquid include a high concentration phosphoric acid solution, an electrolytic processing liquid containing HEDP (1-hydroxyethylidene-diphosphonic acid) and NMI (N-methylimidazole) as main components, an electrolytic processing liquid containing HEDP, NH₄OH, and BTA (benzotriazole) as main components. In this case, it is preferable to use electrolytic processing liquid containing HEDP, NH₄OH, and BTA in view of improving a flattening capability.

The same kind of electrolytic processing liquid is not required to be used as the anode liquid and the cathode liquid. However, the anode liquid and the cathode liquid should be isolated electrically. This is because of the following reason: If the anode liquid and the cathode liquid are not isolated electrically, short-cut of electricity may occur between the anode electrode 31 and the cathode electrode 32 through the electrolytic processing liquid. As a result, the electricity cannot be fed to the copper film 6 on the substrate W, and hence a desired processing cannot be performed.

Thus, in the present embodiment, there are provided an anode liquid path (i.e., the first supply passage 51, the manifold 41, the liquid holes 48, the reservoir 30A, and the first discharge passage 61) and a cathode liquid path (i.e., the second supply passage 52, the manifold 42, the liquid holes 49, the reservoir 30B, and the second discharge passage 62) independently of each other. Further, the partition wall 35 and the insulation member 36 are disposed between the anode electrode 31 and the cathode electrode 32 to divide the anode liquid and the cathode liquid from each other. In this manner, according to this embodiment, the anode liquid and the cathode liquid can be supplied to the copper film 6 while being electrically isolated.

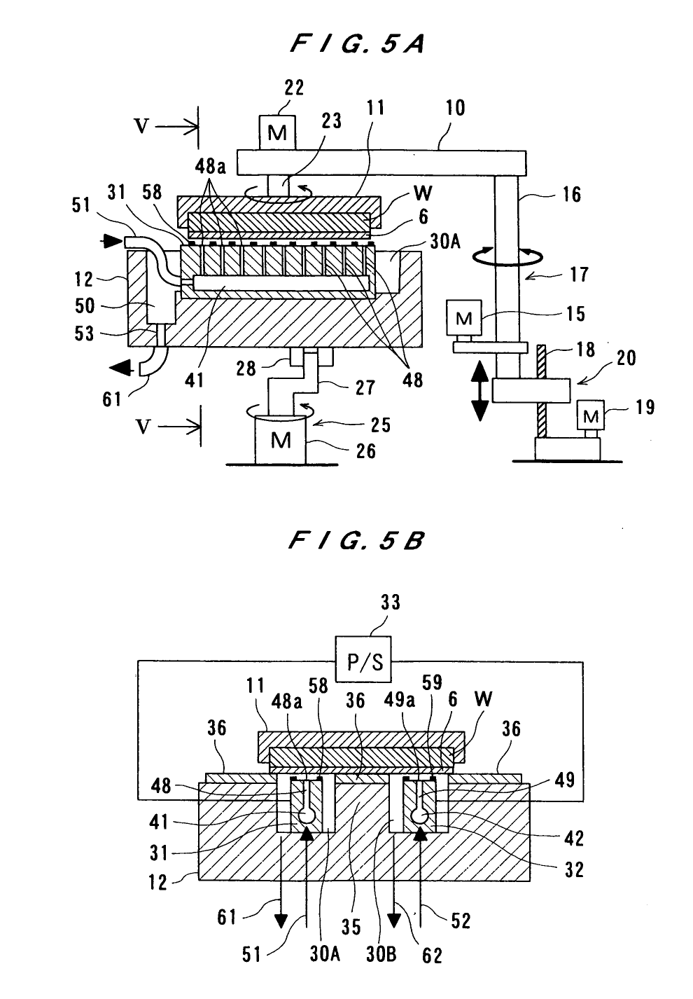

Next, another example of the structure of the electrolytic processing apparatus will be described with reference to FIGS. 5A and 5B. FIG. 5A is a cross-sectional view showing another structure of the electrolytic processing apparatus configured to perform the electrolytic processing method according to the first embodiment of the present invention, and FIG 5B is a cross-sectional view taken along a line V-V shown in FIG. 5A.

As shown in FIGS. 5A and 5B, a plurality of weirs 58 are provided on the upper surface of the anode electrode 31 so as to surround the respective openings 48a of the liquid holes 48. Similarly, a plurality of weirs 59 are provided on the upper surface of the cathode electrode 32 so as to surround the respective openings 49a of the liquid holes 49. With such arrangements, the anode liquid and the cathode liquid, which have been discharged respectively from the liquid holes 48 and 49, can be retained on the upper surfaces of the anode electrode 31 and the cathode electrode 32. Therefore, electricity can be securely fed to the copper film 6 on the substrate W through the anode liquid and the cathode liquid, and hence processing efficiency can be improved.

Material of the weirs 58 and 59 is required to be elastic so as not to cause damage to the copper film 6 upon contact with the substrate W and to have corrosion resistance to the electrolytic processing liquid. For example, O-rings made of fluoro rubber (FPM: Ethylene Propylene Methylene linkage) or ethylene propylene rubber (EPDM: Ethylene Propylene Diene Methylene linkage) may be used as the weirs 58 and 59. In this case, annular grooves may be formed around the weirs 58 and 59, respectively, so that these O-rings are fitted into the annular grooves.

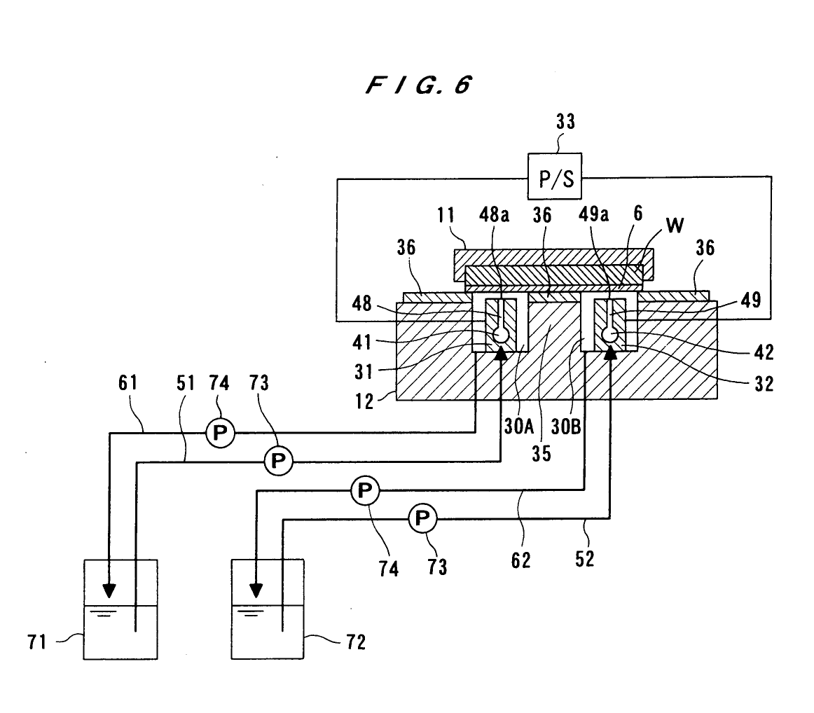

Next, a second embodiment of the present invention will be described with reference to FIG. 6. FIG. 6 is a cross-sectional view showing an electrolytic processing apparatus configured to perform an electrolytic processing method according to the second embodiment of the present invention. Components and operations of the present embodiment, which will not be described below, are identical to those of the first embodiment described already, and will not be described repetitively.

As shown in FIG. 6, the electrolytic processing apparatus comprises a first storing tank 71 for storing the anode liquid and a second storing tank 72 for storing the cathode liquid. The first storing tank 71 is connected to the manifold 41 of the anode electrode 31 through the first supply passage 51, and the second storing tank 72 is connected to the manifold 42 of the cathode electrode 32 through the second supply passage 52. Pumps 73 are provided on the first supply passage 51 and the second supply passage 52, respectively, so that the anode liquid and the cathode liquid stored respectively in the first storing tank 71 and the second storing tank 72 are delivered to the manifolds 41 and 42 by the pumps 73. The purpose of independently providing the first storing tank 71 for the anode liquid and the second storing tank 72 for the cathode liquid is to prevent short cut through the electrolytic processing liquid.

The reservoir 30A in which the anode electrode 31 is accommodated communicates with the first storing tank 71 through the first discharge passage 61, and the reservoir 30B in which the cathode electrode 32 is accommodated communicates with the second storing tank 72 through the second discharge passage 62. Pumps 74 are provided on the first discharge passage 61 and the second discharge passage 62, so that the anode liquid and the cathode liquid stored respectively in the reservoirs 30A and 30B are recovered to the first storing tank 71 and the second storing tank 72. The anode liquid and the cathode liquid, which have been recovered to the first storing tank 71 and the second storing tank 72, are supplied to the anode electrode 31 and the cathode electrode 32 through the first supply passage 51 and the second supply passage 52, thereby being used again to process the copper film 6 on the substrate W. The pumps 74, which are provided on the first and second discharge passages 61 and 62, are effective especially in a case where the electrolytic processing liquids (i.e., the anode liquid and the cathode liquid) have a high viscosity and a poor fluidity.

As described above, according to the present embodiment, since the anode liquid and the cathode liquid can be recovered to be reused, cost required for the electrolytic processing liquids (i.e., the anode liquid and the cathode liquid) can be reduced compared with the first embodiment. In this embodiment also, there are provided an anode liquid circulation path (i.e., the first supply passage 51, the manifold 41, the liquid holes 48, the reservoir 30A, the first discharge passage 61, and the first storing tank 71) and a cathode liquid circulation path (i.e., the second supply passage 52, the manifold 42, the liquid holes 49, the reservoir 30B, the second discharge passage 62, and the second storing tank 72) independently of each other. Therefore, the electrical isolation between the anode liquid and the cathode liquid can be maintained.

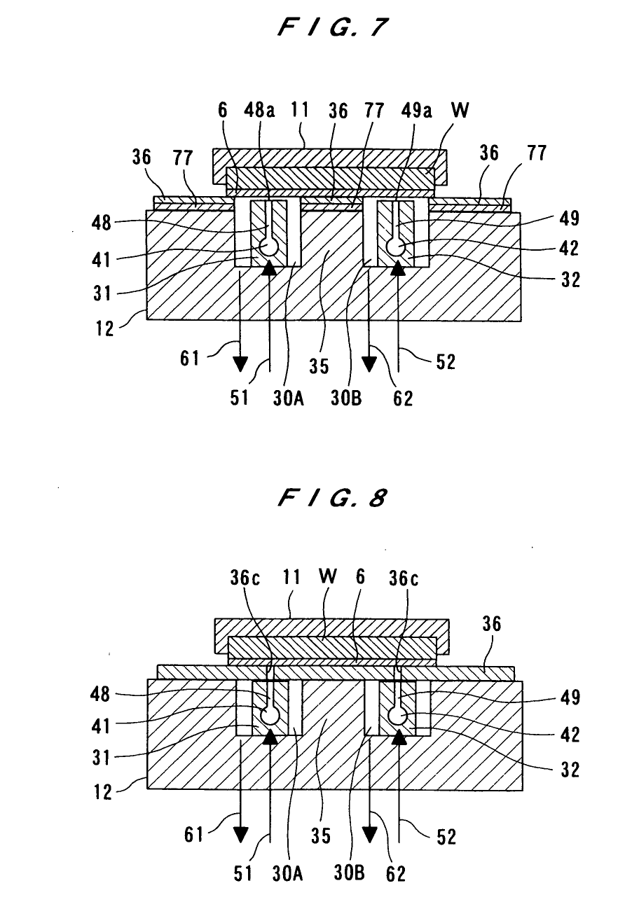

Next, a third embodiment of the present invention will be described with reference to FIG. 7. FIG. 7 is a cross-sectional view showing an electrolytic processing apparatus configured to perform an electrolytic processing method according to the third embodiment of the present invention. Components and operations of the present embodiment, which will not be described below, are identical to those of the first embodiment described already, and will not be described repetitively.

As shown in FIG. 7, an elastic member 77 is provided between the insulating members 36 and the processing table 12. This elastic member 77 is disposed so as to cover the almost entire upper surface of the processing table 12. Since the elastic member 77 is provided, it is possible to reduce the pressure applied between the copper film 6 and the insulating members 36 upon contact and to provide a uniform pressure distribution over the entire upper surfaces (contact surfaces) of the insulating members 36. In a case where the resin pad having a sawtooth cross section shown in FIG. 4 is used as the insulating members 36, it is preferable to provide the elastic member 77 between the resin pad and the processing table 12. Such an arrangement can prevent the convex portions of the resin pad from strongly pressing the substrate W.

Next, a fourth embodiment of the present invention will be described with reference to FIG. 8. FIG. 8 is a cross-sectional view showing an electrolytic processing apparatus configured to perform an electrolytic processing method according to the fourth embodiment of the present invention. Components and operations of the present embodiment, which will not be described below, are identical to those of the first embodiment described already, and will not be described repetitively.

As shown in FIG. 8, the insulating member 36 used in this embodiment is a single piece, and is attached to the processing table 12 so as to cover the upper surfaces of the partition wall 35, the anode electrode 31, and the cathode electrode 32. This insulating member 36 has a plurality of through-holes 36c for allowing the anode liquid and the cathode liquid to pass through the insulating member 36. These through-holes 36c are formed at positions corresponding to the openings 48a and 49a of the liquid holes 48 and 49 formed in the anode electrode 31 and the cathode electrode 32, so that the anode liquid and the cathode liquid supplied to the manifolds 41 and 42 flows through the liquid holes 48 and 49 and the through-holes 36c to be in contact with the copper film 6 on the substrate W.

According to the present embodiment, a smooth contact surface having no gap is realized by the use of the single insulating member 36. Therefore, scratches can be prevented from being produced on the copper film 6 on the substrate W, and the attachment of the insulating member 36 to the processing table 12 can be easily conducted. In a case of using the elastic pad for the insulating member 36, uniform distribution of the pressure applied to the substrate W can be provided over the entire surface of the substrate W.

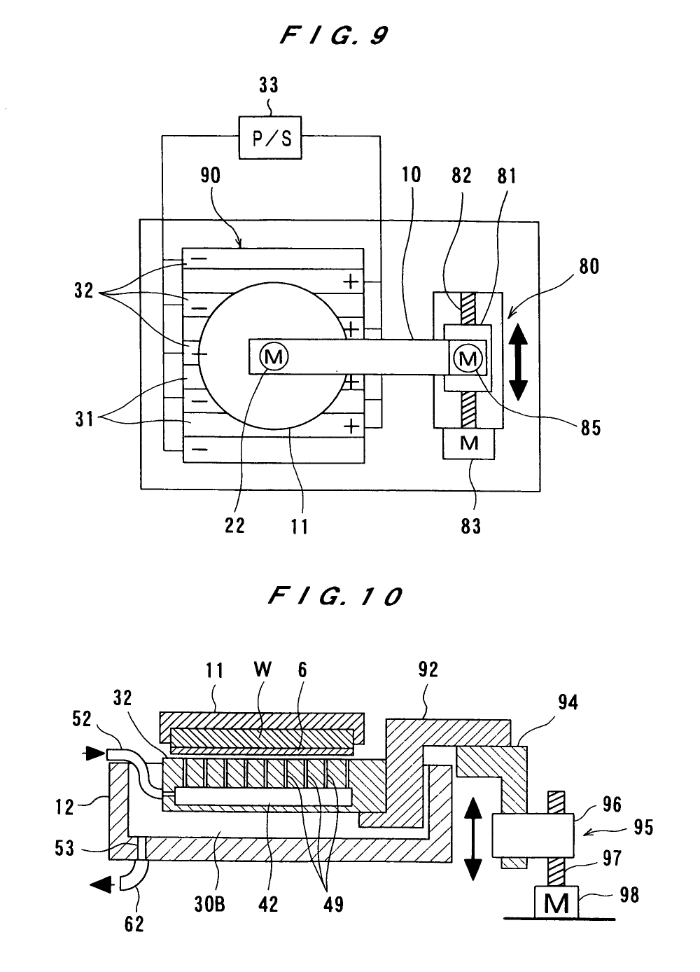

Although the single anode electrode and the single cathode are provided in the first through fourth embodiments, a plurality of anode electrodes and a plurality of cathode electrodes may be provided. Such a structural example will be described below with reference to FIG. 9. FIG. 9 is a plan view showing an electrolytic processing apparatus configured to perform an electrolytic processing method according to a fifth embodiment of the present invention. Components and operations of the present embodiment, which will not be described below, are identical to those of the first embodiment described already, and will not be described repetitively.

As shown in FIG. 9, the electrolytic processing apparatus comprises a plurality of anode electrodes 31 and a plurality of cathode electrodes 32, which are arranged in parallel with each other. These anode electrodes 31 and the cathode electrodes 32 are disposed alternately and connected to the anode and the cathode of the power supply 33. Although not shown, the partition wall 35 and the insulating member 36 are disposed between each anode electrode 31 and each cathode electrode 32 (see FIG. 3B) to electrically insulate the anode liquid and the cathode liquid.

In this embodiment, a translating mechanism 80 is provided instead of the swinging mechanism. This translating mechanism 80 comprises a movable frame 81 to which the arm 10 is fixed, a ball screw 82 passing through the movable frame 81, and a reciprocating motor 83 for rotating the ball screw 82. The ball screw 82 extends horizontally along an arrangement direction of the anode electrodes 31 and the cathode electrodes 32. With such a structure, when the reciprocating motor 83 is driven, the movable frame 81 and the arm 10 are reciprocated, whereby the substrate carrier 11 performs reciprocating movement (scanning movement) along the arrangement direction of the anode electrodes 31 and the cathode electrodes 32 (i.e., a direction perpendicular to a longitudinal direction of the anode electrodes 31 and the cathode electrodes 32). In this case, a distance, i.e., a stroke, of the relative movement between the substrate carrier 11 and the processing table 12 is preferably equal to or larger than an interval of the cathode electrodes 32.

A vertical-movement motor 85 is mounted on the upper end of the moveable flame 81. A non-illustrated ball screw, which extends vertically, is connected to the vertical-movement motor 85. The end portion of the arm 10 is attached to this ball screw, and the arm 10 moves up and down through the ball screw by the actuation of the vertical-movement motor 85. A size of a rectangular processing section 90 comprising the anode electrodes 31, the cathode electrodes 32, and the insulating members 36 is set to be larger than the diameter of the substrate W. For example, a width of the processing section 90 is twice or more as large as a scrolling radius of the processing table 12.

According to the present embodiment having such a structure, the plurality of the anode electrodes (feeding electrodes) 31 can feed electricity to the wide portion of the substrate W through the anode liquid in a non-contact manner. Further, the plurality of the cathode electrodes (processing electrodes) 32 and the plurality of the insulating members 36 can securely process the entire surface of the copper film 6 on the substrate W.

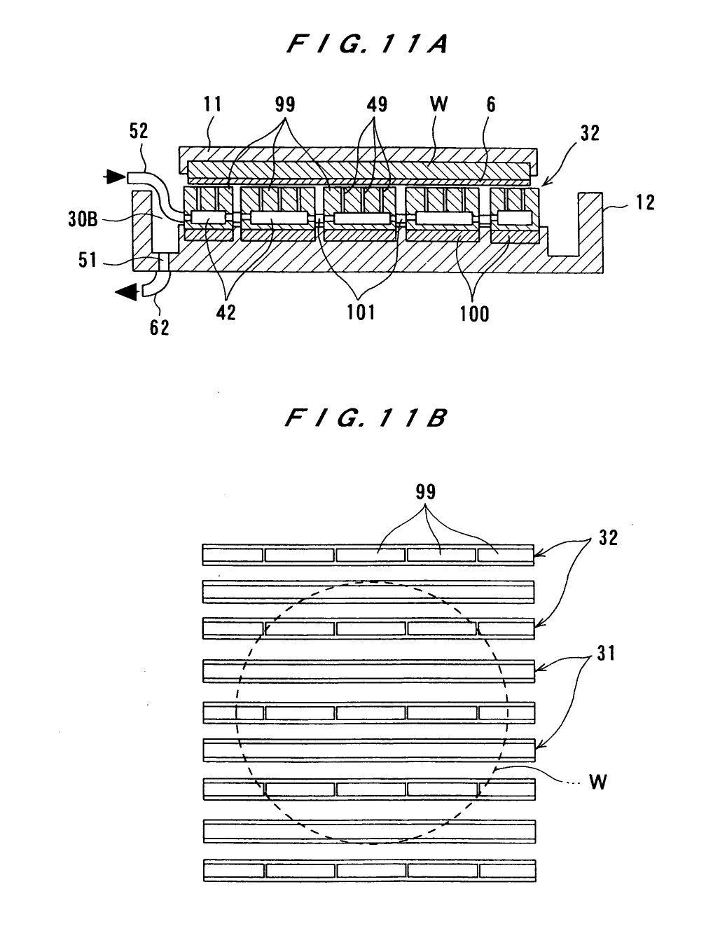

In order to change a processing rate, a distance adjusting mechanism for adjusting a distance between the cathode electrodes 32 and the substrate W may be provided. Such a structure will be described below with reference to FIG. 10. FIG. 10 is a cross-sectional view showing an electrolytic processing apparatus configured to perform an electrolytic processing method according to a sixth embodiment of the present invention. Components and operations of the present embodiment, which will not be described below, are identical to those of the fifth embodiment described already, and will not be described repetitively.

As shown in FIG. 10, the cathode electrodes 32 are supported by support arms 92, respectively, and these support arms 92 are connected to distance adjusting mechanisms 95 through L-shaped arms 94, respectively. Each of the distance adjusting mechanisms 95 comprises a movable frame 96 to which the L-shaped arm 94 is fixed, a ball screw 97 passing through the movable frame 96, and a distance adjusting motor 98 for rotating the ball screw 97. When the distance adjusting motor 98 rotates the ball screw 97, the movable frame 96 moves up and down to move the cathode electrode 32 together with the L-shaped arm 94 and the support arm 92. The cathode electrode 32 is positioned in the reservoir 30B by the support of the support arm 92 and moves up and down within the reservoir 30B. In this embodiment, the reservoir 30B has a flat bottom, and the cathode liquid flows into the second discharge passage 62 through the discharge hole 53 formed in the bottom of the reservoir 30B.

Although only one support arm 92, one L-shaped arm 94, and one distance adjusting motor 98 are illustrated in FIG. 10, the plurality of the support arms 92, the L-shaped arms 94, and the distance adjusting motors 98 are provided for each of the cathode electrodes 32. Specifically, the respective cathode electrodes 32 can move up and down independently, so that a distance between each cathode electrode 32 and the substrate W can be changed according to thickness distribution of the copper film 6. For example, a distance between the substrate W and the cathode electrode 32 facing a thick portion of the copper film 6 is set to be small, and a distance between the substrate W and the cathode electrode 32 facing a thin portion of the copper film 6 is set to be large, whereby a uniform thickness can be obtained over the entire surface of the substrate W. Further, if all of the cathode electrodes 32 are positioned in the vicinity of the substrate W, the processing rate as a whole can increase. Although the translating mechanism for reciprocating (translating) the substrate carrier 11 is used in the fifth and sixth embodiments, a swinging mechanism as shown in FIG. 3A may be used alternatively.

Next, a seventh embodiment will be described below with reference to FIGS. 11A and 11B. FIG. 11A is a cross-sectional view showing an electrolytic processing apparatus configured to perform an electrolytic processing method according to the seventh embodiment of the present invention, and FIG. 11B is a plan view of the anode electrodes and the cathode electrodes when viewed from above. Components and operations of the present embodiment, which will not be described below, are identical to those of the first embodiment described already, and will not be described repetitively.

As shown in FIGS. 11A and 11B, each of the cathode electrodes 32 is divided into a plurality of electrode parts 99 at positions arranged in a longitudinal direction of the cathode electrode 32. The electrode parts 99 are aligned in the longitudinal direction of the cathode electrode 32. A distance adjusting mechanism 100 for adjusting a distance between the substrate W and each of the electrode parts 99 is disposed on each of lower portions of the electrode parts 99. In this embodiment, a piezoelectric element (a piezoelectric actuator) is used as the distance adjusting mechanism 100.

As with the first embodiment, a manifold 42 and a plurality of liquid holes 49 communicating with the manifold 42 are formed in each of the electrode parts 99. The adjacent manifolds 42 communicate with each other through an elastic tube 101 so that the cathode liquid, which is supplied from the second supply passage 52, is supplied to the respective manifolds 42 through the elastic tube 101. The elastic tubes 101 should preferably be deformable to such a degree that the electrode part 99 can move up and down without being affected by the movement of the adjacent electrode part 99. Although not shown, in this embodiment also, the partition wall 35 and the insulating member 36 are disposed between each anode electrode 31 and each cathode electrode 32 (see FIG. 3B) to electrically insulate the anode liquid and the cathode liquid.

The electrode parts 99 are connected to the power supply 33 (see FIG. 3B) and a controller (which will be described later) through wires so that current densities of the electrode parts 99 are changed independently by the controller. Therefore, the current densities of the electrode parts 99 and the distance between each of the electrode parts 99 and the substrate W can be changed according to the thickness distribution of the copper film 6. Accordingly, a uniform film thickness can be obtained over the entire surface of the substrate W. For example, the current density of the electrode part 99 facing a thick portion of the copper film 6 is set to be high, and the current density of the electrode part 99 facing a thin portion of the copper film 6 is set to be low, whereby a uniform film thickness can be obtained over the entire surface of the substrate W. Further, in a case where a CMP process is to be performed after the electrolytic processing, the copper film 6 may be processed in such a manner that a peripheral portion is left thick in consideration of a processing characteristic of the CMP process. In this manner, according to the present embodiment, a profile (i.e., a film thickness distribution) of the substrate can be controlled precisely.

The embodiments described above can be combined as desired. For example, the resin elastic pad having a sawtooth cross-section may be used in the second through seventh embodiments. Further, the first storing tank 71 and the second storing tank 72 may be incorporated into the third through seventh embodiments.

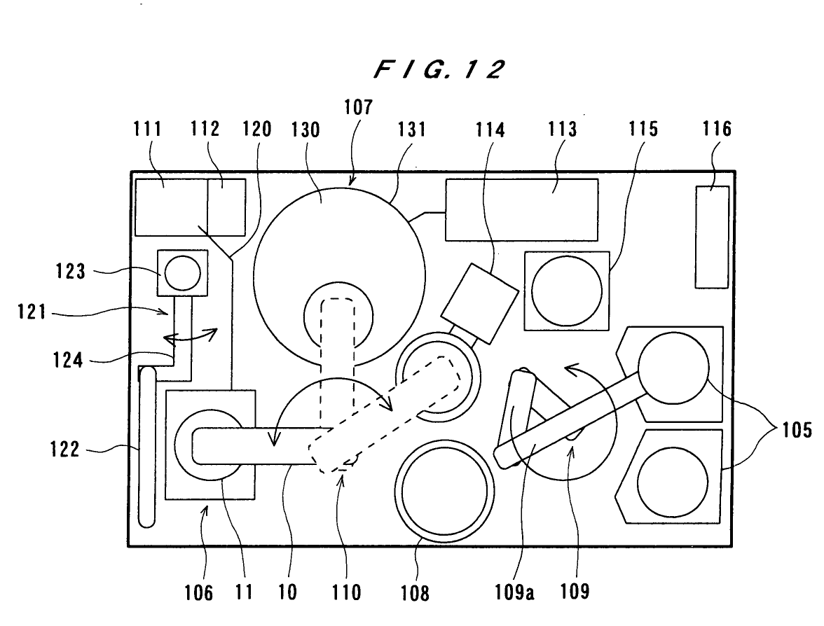

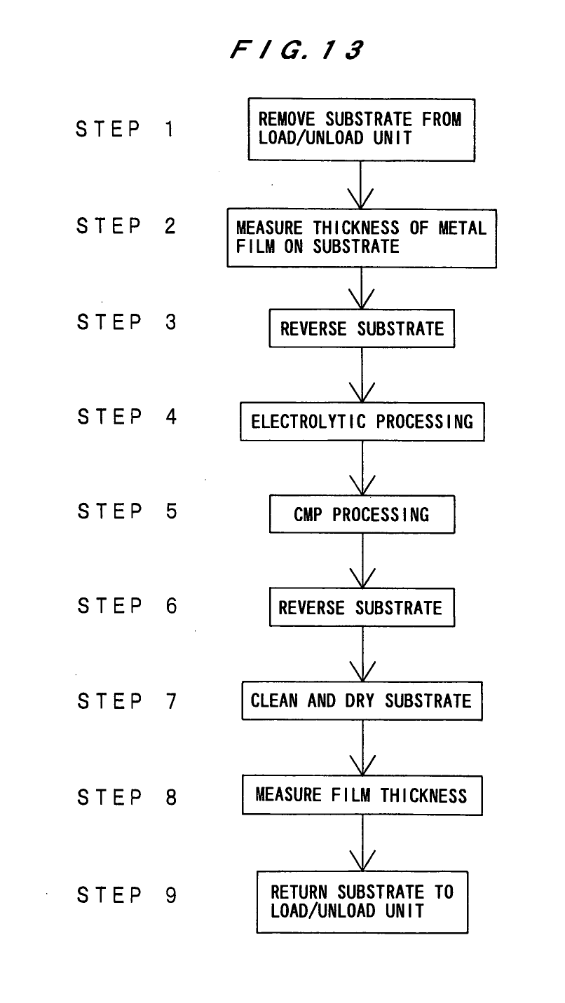

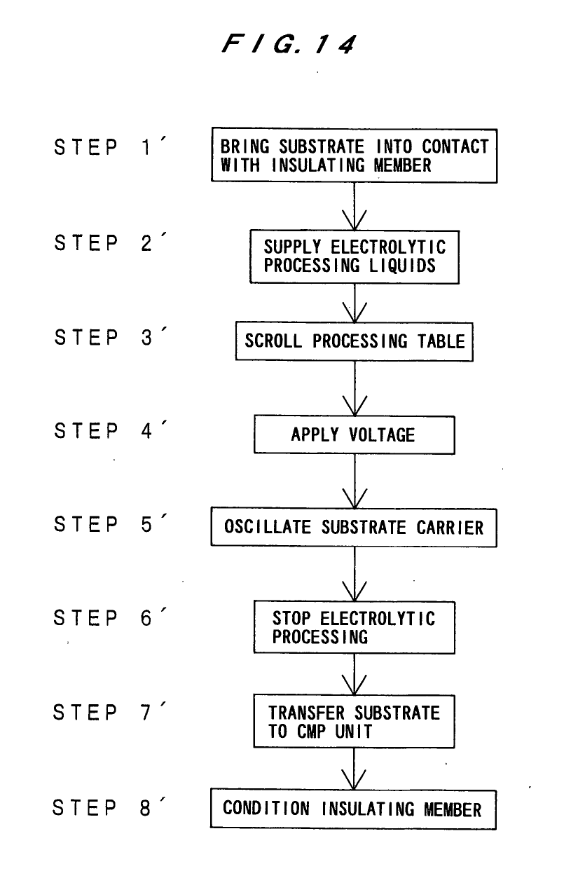

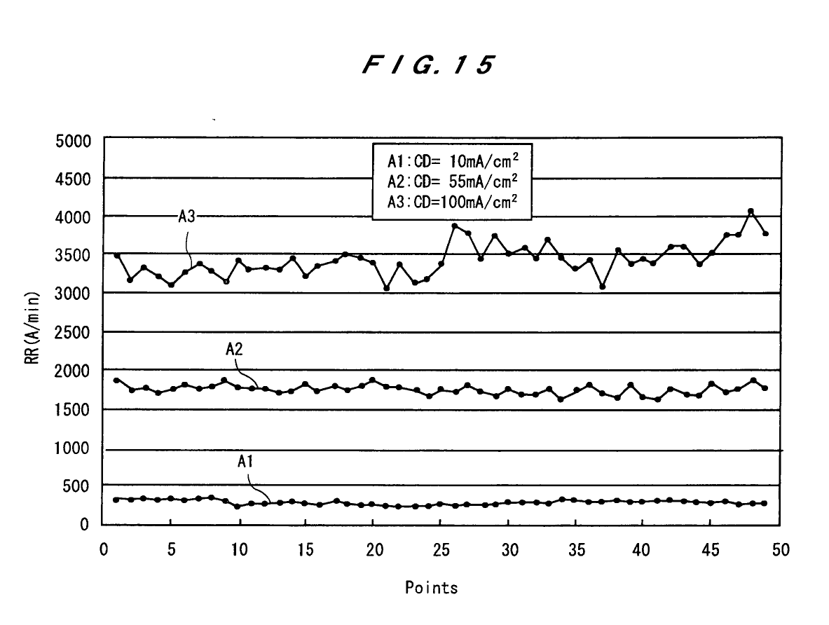

Next, a substrate processing system incorporating the above-mentioned electrolytic processing apparatus will be described with reference to FIG. 12. FIG. 12 is a plan view showing the substrate processing system incorporating the electrolytic processing apparatus. The electrolytic processing apparatus described in the seventh embodiment is used as an electrolytic processing unit incorporated in this substrate processing system. However, the electrolytic processing apparatus to be used in this substrate processing system is not limited to the seventh embodiment, and any one of the electrolytic processing apparatuses described in the first through sixth embodiments may be used.

As shown in FIG. 12, the substrate processing system comprises two load and unload units 105 for carrying in and carrying out a substrate (e.g., a semiconductor wafer) W, an electrolytic processing unit (electrolytic processing apparatus) 106 for removing a copper film (metal film) on the substrate by etching, a CMP unit (Chemical Mechanical Polishing unit) 107 for chemically mechanically polishing the copper film on the substrate, a cleaning unit 108 for cleaning and drying the substrate which has been polished, and a transfer robot 109 and a transfer unit 110 for transferring the substrate.

The substrate processing system further comprises an electrolytic processing liquid supply unit 111 for supplying electrolytic processing liquids (an anode liquid and a cathode liquid) to the electrolytic processing unit 106, an electrolytic processing liquid management unit 112 for managing the electrolytic processing liquids, a polishing liquid supply unit 113 for supplying a polishing liquid to the CMP unit 107, a reversing unit 114 for reversing the substrate, a film-thickness measuring unit (a film-thickness monitor) 115 for measuring a film thickness of the substrate, and a control unit (controller) 116 for controlling operations of the substrate processing system. All of these units are disposed in a rectangular frame 117.

Cassettes (not shown) are placed respectively on the load and unload units 105, and a plurality of substrates are accommodated in these cassettes in such a state that surfaces to be processed (i.e., surfaces each having a copper film) face upwardly. The transfer robot 109 has an articulated arm 109a which is bendable and stretchable in a horizontal plane and has upper and lower holding portions which are separately used as a dry finger and a wet finger. The load and unload units 105, the film-thickness measuring unit 115, the reversing unit 114, and the cleaning unit 108 are disposed in such positions that the articulated arm 109a of the transfer robot 109 can reach, and the transfer robot 109 transfers the substrate between these units.

The film-thickness measuring unit 115 measures a film-thickness distribution of the substrate before the processing, and the control unit 116 controls the CMP unit 107 and the electrolytic processing unit 106 based on the measured film-thickness distribution so as to achieve a desired processing rate. The film-thickness measuring unit 115 can also be used as an end point detector for detecting an end point of the processing. An eddy-current-type film-thickness measuring unit utilizing eddy current is preferably used as the film-thickness measuring unit 115.

Transferring of the substrate between the reversing unit 114, the CMP unit 107, and the electrolytic processing unit 106 is carried out by the transfer unit 110. This transfer unit 110 comprises the swinging mechanism 17 and the vertical-movement mechanism 20 shown in FIG. 3A. Specifically, the transfer unit 110 comprises the arm 10 to which the substrate carrier 11 is fixed, the swing motor 15, the pivot shaft 16, the ball screw 18, and the vertical-movement motor 19 (see FIG. 3A). The substrate carrier 11 is rotated about the pivot shaft 16 while holding the substrate, thereby transferring the substrate between the revering unit 114, the CMP unit 107, and the electrolytic processing unit 106. In this manner, the transfer unit 110 can transfer the substrate without releasing the substrate from the substrate carrier 11, and hence throughput can be improved.

The electrolytic processing unit 106 is connected to the electrolytic processing liquid supply unit 111 via a liquid delivery line 120. This liquid delivery line 120 comprises the first supply passage 51, the second supply passage 52, the first discharge passage 61, and the second discharge passage 62 (see FIG. 6). Specifically, the anode liquid and the cathode liquid are supplied from the electrolytic processing liquid supply unit 111 to the anode electrodes 31 and the cathode electrodes 32 of the electrolytic processing unit 106 through the first supply passage 51 and the second supply passage 52 of the liquid delivery line 120. The anode liquid and the cathode liquid, which have been supplied to the electrolytic processing unit 106, are recovered to the electrolytic processing liquid supply unit 111 through the first discharge passage 61 and the second discharge passage 62 of the liquid delivery line 120. In this case also, the circulating path of the anode liquid and the circulating path of the cathode liquid are provided independently, so that electrical insulation between the anode liquid and the cathode liquid is maintained. In this substrate processing system, the same king of electrolytic processing liquid is used as the anode liquid and the cathode liquid. Specifically, concentrations of the main components contained respectively in the anode liquid and the cathode liquid are the same as each other at a time of starting the electrolytic processing.

Generally, the processing rate of the electrolytic processing depends on a temperature of the electrolytic processing liquid. Specifically, when the temperature of the electrolytic processing liquid is high, the processing rate tends to increase. Therefore, in order to stabilize the electrolytic processing, the electrolytic processing liquid is required to be managed to keep an appropriate temperature. Further, when a certain component of the electrolytic processing liquid is consumed, then desirable pH and electric conductivity cannot be maintained. Generally, in order to perform an excellent electrolytic processing, the electric conductivity should be kept to several tens mS/cm. If the electric conductivity is changed greatly, selectivity desirable for a processing of fine interconnections pattern cannot be obtained. Further, if the electrolytic processing liquid is used for a certain period of time while being circulated, a concentration of a removed metal component becomes high, and the metal precipitates in the electrolytic processing liquid to cause damage to the surface, to be processed, of the substrate.

For this reason, the management of the electrolytic processing liquid is very important, and the substrate processing system has the electrolytic processing liquid management unit 112. This electrolytic processing liquid management unit 112 is designed to manage the electrolytic processing liquid based on at least one of elements composed of a temperature, an electric conductivity, pH, and a concentration of metal (e.g., copper) contained in the electrolytic processing liquid.

In this embodiment, a conditioning unit 121 is disposed alongside the electrolytic processing unit 106. This conditioning unit 121 is provided for the following reason: In the electrolytic processing unit 106, since the insulating members scrape the complex formed in the copper film on the substrate, by-products such as the complex are deposited on the upper surfaces of the insulating members with time. In order to maintain the excellent stability and uniformity of the processing over the surface of the substrate, it is required to maintain the state of the surfaces (upper surfaces) of the insulating members constant at all times. Thus, for the purpose of removing the by-products which have been deposited on the upper surfaces of the insulating members, the conditioning unit 121 is provided for conditioning the contact surfaces of the insulating members. This conditioning unit 121 comprises a conditioner 122 for conditioning the contact surfaces of the insulating members, and a swinging mechanism 123 for swinging the conditioner 122. The swinging mechanism 123 has an arm 124, and the conditioner 122 is rotatably attached to a tip end portion of the arm 124. In this embodiment, a cylindrical brush which rotates about its own axis is used as the conditioner 122. Alternatively, the conditioner 122 may comprise a spray for spraying a cleaning liquid onto the contact surfaces of the insulating members.

As shown in FIG. 12, while the electrolytic processing is being performed, the conditioner 122 is positioned beside the electrolytic processing unit 106. After the electrolytic processing is finished and the substrate is transferred away from the electrolytic processing unit 106, the swinging mechanism 123 is activated to move the arm 123 until the conditioner 122 is positioned above the insulating members 36. Next, the swinging mechanism 123 lowers the conditioner 122 to bring it into contact with the contact surfaces of the insulating members 36. At the same time, a non-illustrated rotating motor rotates the conditioner 122 about its own axis. In this state, the conditioner 122 is swung to condition the contact surfaces of the insulating members 36. After the conditioning, the rotation of the conditioner 122 is stopped. Then, the conditioner 122 is elevated and the arm 124 pivots to return the conditioner 122 to its original position.

The CMP unit 107 comprises a polishing table 131 having a polishing pad 130 such as a polishing cloth attached on its upper surface. An upper surface of the polishing pad 130 serves as a polishing surface. The polishing table 131 is rotated about its own axis by a non-illustrate motor. The CMP unit 107 is operated as follows: The substrate carrier 11 and the polishing table 131 are rotated respectively, and the polishing liquid is supplied from the polishing liquid supply unit 113 onto the polishing surface of the polishing table 131. Then, the substrate carrier 11 is lowered to press the substrate against the polishing surface with a predetermined pressure. The polishing liquid supplied from the polishing liquid supply unit 113 comprises, for example, a slurry containing an alkaline solution with fine abrasive grain particles of silica or the like suspended therein. Therefore, the substrate is polished by both a chemical action of the alkaline solution and a mechanical action of the fine abrasive grain particles to a flat mirror finish.

The cleaning unit 108 comprises a substrate holder (e.g., a spin chuck) for holding and rotating the substrate in a substantially horizontal plane at a high speed. This cleaning unit 108 performs a cleaning process (rinsing process) by supplying a cleaning liquid such as pure water (DIW) onto the surface of the substrate while rotating the substrate. Since the cleaning liquid remains on the surface of the substrate which has been cleaned, the cleaning unit 108 subsequently performs a drying process (spin-dry process) by rotating the substrate at a high speed to remove the cleaning liquid by a centrifugal force.

Next, operation of the substrate processing system having the above structure will be described. Firstly, a substrate having a copper film (metal film) on its surface is removed from one of the cassettes on the load and unload unit 105 by the transfer robot 109. The substrate is transferred to the film-thickness measuring unit 115, and the thickness of the copper film at a plurality of process points is measured by the film-thickness measuring unit 115. A measurement result of the film-thickness measuring unit 115 is sent to the control unit 116 so that a pre-profile (i.e., a film-thickness distribution before the processing is performed) is obtained by the control unit 116. This profile is utilized for controlling the electrolytic processing unit 106 and the CMP unit 107. Thereafter, the substrate is transferred to the reversing unit 114 and is reversed by the reversing unit 114 so that the surface having the copper film faces downwardly.

Next, the transfer unit 110 is driven to move the substrate carrier 11 to the reversing unit 114 for thereby allowing the substrate carrier 11 to hold the substrate. Thereafter, the substrate is moved from the reversing unit 114 to the electrolytic processing unit 106 by the transfer unit 110 and is then processed by the electrolytic processing unit 106.

The electrolytic processing is performed in the electrolytic processing unit 106 as follows: The substrate carrier 11 is lowered by the vertical-movement motor 19 (see FIG. 3A) to bring the substrate into contact with the insulating members 36. In this state, the anode liquid is supplied to the gaps between the anode electrodes 31 and the substrate and the cathode liquid is simultaneously supplied to the gaps between the cathode electrodes 32 and the substrate from the electrolytic processing liquid supply unit 111. Thereafter, the processing table 12 is moved by the scrolling mechanism 25 to perform a scrolling motion. Then, voltage is applied between the anode electrodes 31 and the cathode electrodes 32, and the swinging mechanism 17 is activated to reciprocate the substrate carrier 11 horizontally. In this manner, the substrate carrier 11 and the processing table 12 are reciprocated relative to each other so that all portions of the copper film pass over the cathode electrodes 32 and the insulating members 36 alternatively, whereby the complex in the concave portions of the copper film are selectively removed by the insulating members 36.

After a predetermined processing time has elapsed, the application of voltage to the anode electrodes 31 and the cathode electrodes 32 is stopped, the relative movement between the substrate and the processing table 12 is stopped, and the supply of the anode liquid and the cathode liquid is stopped, whereby the electrolytic processing is finished. The substrate carrier 11 is elevated to bring the substrate out of contact with the insulating members 36, and the substrate is transferred together with the substrate carrier 11 to the CMP unit 107 by the transfer unit 110. At this time, for removing residues such as complex existing on the upper surfaces of the insulating members 36, the conditioning unit 121 is operated to perform the conditioning of the upper surfaces (contact surfaces) of the insulating members 36.

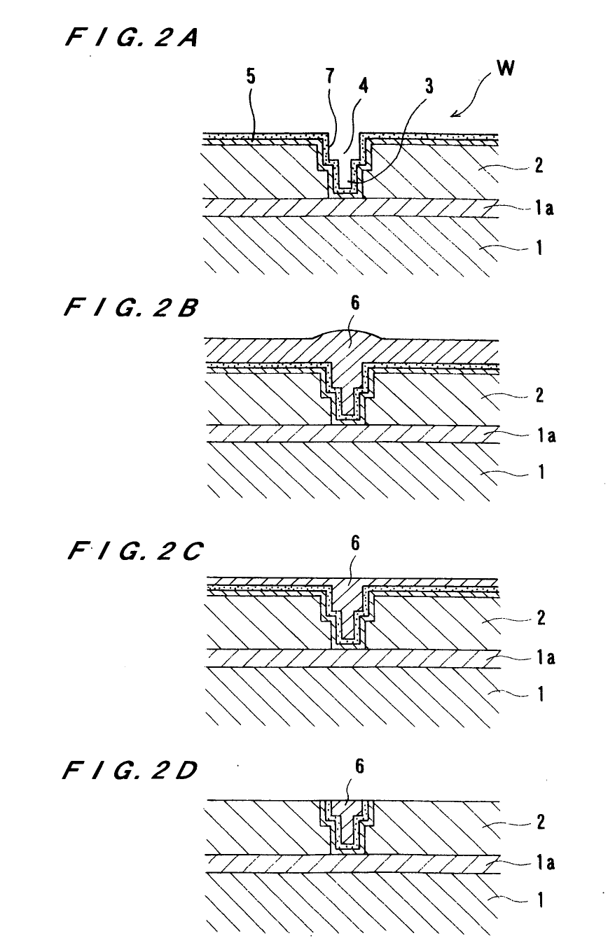

In the CMP unit 107, the polishing table 131 is rotated by a non-illustrated motor, and the substrate carrier 11 is also rotated together with the substrate by the substrate-rotating motor 22 (see FIG. 3A). The polishing liquid is supplied from the polishing liquid supply unit 113 onto the upper surface (i.e., the polishing surface) of the polishing table 131. In this state, the substrate carrier 11 is lowered to press the surface, to be polished, of the substrate against the polishing surface. The substrate is brought into sliding contact with the polishing surface in the presence of the polishing liquid, whereby the surface of the substrate is polished to a flat finish. In this manner, the copper film and the barrier layer are removed and copper interconnections (metal interconnections) are formed on the surface of the substrate (see FIG. 2D).

After the CMP processing, the substrate carrier 11 is elevated to bring the substrate out of contact with the polishing table 131, and then the transfer unit 110 pivots to transfer the substrate to the reversing unit 114. The reversing unit 114 reverses the substrate so that the processed surface faces upwardly. Then, the transfer robot 109 receives the substrate and transfers it to the cleaning unit 108 where the substrate is cleaned.

In the cleaning unit 108, the substrate holder receives the substrate from the transfer robot 109 and rotates the substrate in a horizontal plane. Then, the cleaning liquid is ejected to the surface of the substrate which is being rotated, thus removing the polishing residues such as abrasive grain particles remaining on the substrate. Thereafter, the substrate holder rotates the substrate at a high speed to remove the cleaning liquid from the substrate, thus drying the substrate. After the cleaning process, the substrate is, if necessary, transferred to the film-thickness measuring unit 115 which evaluates whether or not a desired processing result is obtained. Thereafter, the substrate is returned to the cassette of the load and unload unit 105 by the transfer robot 109. In this manner, the substrate processing system according to the present embodiment can achieve a so-called dry-in dry-out process in which a substrate in a dry state is transferred, processed, and returned to the cassette of the load and unload unit 105 while keeping a dry state.

Hereinafter, processing conditions of the electrolytic processing unit 106 will be described. Values within parentheses indicate one example of the processing conditions.

Interval of the cathode electrodes: 40-80 mm (50 mm)

Material of the insulating members: IC1000 or other materials (IC1000)

Pressing force (pressure): 0.25˜2.0 psi (1.0 psi)

Current density: 10˜100 mA/cm² (10, 55, 100 mA/cm²)

Flow rate of the electrolytic processing liquid: 100˜500 ml/min (500 ml/min)

Moving speed (scanning speed) of the substrate carrier: 4˜16 mm/s (10 mm/s)

Speed of rotation of the substrate: 0˜20 min⁻¹ (0 min⁻¹)

Substrate index rotational angle: 45°/scan (45°/scan)

Table scroll radius: 10 mm (10 mm)

Table scrolling speed: 50˜200 min⁻¹ (200 min⁻¹)

Processing time: 80 second (80 second)

Electrolytic processing liquid: phosphoric acid, HEDP, or the like (85% phosphoric acid)

FIG. 15 shows an experiment result obtained under the condition defined by the values in the parentheses. FIG. 15 is a graph illustrating a relationship between current density of the cathode electrode and a processing rate (removal rate). In FIG. 15, the ordinate shows a processing rate and the abscissa shows processing points (49 points) arranged in a circumferential direction of the substrate. The substrate index rotation is a motion in which the substrate rotates in one direction by a predetermined angle (e.g., 45°) per reciprocation of the table. Basically, the substrate carrier is operated in such a manner that the substrate performs the index rotation when the substrate is not continuously rotated (speed of rotation=0 min⁻¹), and the substrate does not perform the index rotation when the substrate is continuously rotated (speed of rotation >0 min⁻¹).

As can be seen from FIG. 15, the higher the current density is, the higher the processing rate increases. Further, FIG. 15 shows that the lower the processing rate is, the more uniform processing rate can be obtained. That is, although the processing rate increases as the current density becomes high, the processed surface becomes rough. Therefore, the current density should be determined in consideration of the processing rate and the uniformity of the processing. The experiment showed that there is no relationship between the roughness of the surface and other factors, i.e., the moving speed (scanning speed) of the substrate, the scrolling speed of the table, and the flow rate of the electrolytic processing liquid.

According to the present invention, because the insulating member is disposed between the feeding electrode and the processing electrode, the feeding of electricity to the metal film on the substrate can be securely performed and a portion of the metal film facing to the processing electrode can be securely processed. Therefore, the processing pressure can be lowered and a desired processing rate can be ensured while suppressing damage to the substrate, resulting in an increased throughput.

Although certain preferred embodiments of the present invention have been shown and described in detail, it should be understood that various changes and modifications may be made therein without departing from the scope of the appended claims.

What is claimed is:

1. An electrolytic processing method for processing a substrate having a metal film formed on a surface thereof, said method comprising:
providing at least one feeding electrode and at least one processing electrode on a table;
providing an insulating member between said feeding electrode and said processing electrode;
holding the substrate by a substrate carrier in such a state that the metal film faces said feeding electrode and said processing electrode;
bringing the substrate into contact with said insulating member;
supplying a first electrolytic processing liquid and a second electrolytic processing liquid to gaps between said feeding electrode and the substrate and between said processing electrode and the substrate, respectively, while the first electrolytic processing liquid and the second electrolytic processing liquid are electrically isolated;
applying voltage between said feeding electrode and said processing electrode; and
making a relative movement between said substrate carrier and said table to electrically process the metal film.

2. An electrolytic processing method according to claim 1, wherein the relative movement between said substrate carrier and said table is performed in such a manner that a predetermined processing point of the metal film passes over said processing electrode and said insulating member alternatively.

3. An electrolytic processing method according to claim 1, wherein the first electrolytic processing liquid is supplied through a plurality of openings formed on an upper surface of said feeding electrode, and the second electrolytic processing liquid is supplied through a plurality of openings formed on an upper surface of said processing electrode.

4. An electrolytic processing method according to claim 3, wherein a plurality of weirs are provided so as to surround said plurality of openings so that the first electrolytic processing liquid is retained on the upper surface of said feeding electrode and the second electrolytic processing liquid is retained on the upper surface of said processing electrode.

5. An electrolytic processing method according to claim 1, wherein said insulating member is a single piece disposed so as to cover said feeding electrode and said processing electrode, and the first and second electrolytic processing liquids are supplied to the metal film through through-holes formed in said insulating member.

6. An electrolytic processing method according to claim 1, wherein the electrolytic processing is performed while the substrate is in sliding contact with said insulating member comprising an elastic pad.

7. An electrolytic processing method according to claim 1, wherein the electrolytic processing is performed while the substrate is in sliding contact with said insulating member comprising a fixed abrasive pad.

8. An electrolytic processing method according to claim 6, wherein said elastic pad is a resin pad having a sawtooth cross section.

9. An electrolytic processing method according to claim 1, wherein an elastic member is disposed between said table and said insulating member.

10. An electrolytic processing method according to claim 1, further comprising circulating the first electrolytic processing liquid and the second electrolytic processing liquid independently while keeping electrical insulation.

11. An electrolytic processing method according to claim 1, wherein main components contained respectively in the first electrolytic processing liquid and the second electrolytic processing liquid are the same as each other.

12. An electrolytic processing method according to claim 11, wherein concentrations of the main components contained respectively in the first electrolytic processing liquid and the second electrolytic processing liquid are the same as each other at a time of starting the electrolytic processing.

13. An electrolytic processing method according to claim 1, the relative movement between said substrate carrier and said table comprises at least one of rotating motion of said substrate carrier, swinging motion of said substrate carrier, and translating motion of said substrate carrier.

14. An electrolytic processing method according to claim 1, the relative movement between said substrate carrier and said table comprises scrolling motion of said table.

15. An electrolytic processing method according to claim 1, wherein a plurality of said feeding electrodes and a plurality of said processing electrodes are arranged alternately.

16. An electrolytic processing method according to claim 15, wherein a stroke of the relative movement between said substrate carrier and said table is equal to or larger than an interval of said plurality of said processing electrodes.

17. An electrolytic processing method according to claim 15, wherein a thickness distribution of the metal film is adjusted by changing a distance between each of said plurality of said processing electrodes and the substrate.

18. An electrolytic processing method according to claim 1, wherein said processing electrode is divided into a plurality of electrode parts aligned in a longitudinal direction of said processing electrode.

19. An electrolytic processing method according to claim 18, wherein a thickness distribution of the metal film on the substrate is adjusted by controlling a distribution of currents to be supplied to said plurality of said processing electrodes.

20. A substrate processing method comprising:
removing a substrate from a load and unload unit;
electrically processing a metal film formed on the substrate;
after said electrical processing, cleaning and drying said substrate; and
returning the substrate to said load and unload unit;
wherein said electrical processing comprises:
bringing the substrate into contact with an insulating member disposed between at least one feeding electrode and at least one processing electrode;
supplying a first electrolytic processing liquid and a second electrolytic processing liquid to gaps between said feeding electrode and the substrate and between said processing electrode and the substrate, respectively, while the first electrolytic processing liquid and the second electrolytic processing liquid are electrically isolated;
applying voltage between said feeding electrode and said processing electrode; and
making a relative movement between said insulating member and the substrate.

21. A substrate processing method according to claim 20, further comprising, after said electrical processing, polishing the metal film remaining on the substrate.

22. A substrate processing method according to claim 20, further comprising, before said electrical processing, measuring a thickness of the metal film on the substrate.
